(19) United States
(12) Patent Application Publication
(10) Pub. No.: US 2007/0271259 A1
(43) Pub. Date: Nov. 22, 2007

(54) System and method for geographically focused crawling

(75) Inventors: Hyun Chul Lee, Toronto (CA); Yingbo Miao, Halifax (CA); Weizheng Gao, Halifax (CA)

Correspondence Address: BERESKIN AND PARR, 40 KING STREET WEST, BOX 401, TORONTO, ON, M5H 3Y2, US

(73) Assignee: IT Interactive Services Inc., Halifax (CA)

(21) Appl. No.: 11/798,793

(22) Filed: May 17, 2007

Related U.S. Application Data
(60) Provisional application No. 60/800,832, filed on May 17, 2006.

(51) Int. Cl. G06F 17/30

(52) U.S. Cl. 707/5

(57) ABSTRACT

A system and method for crawling Web content. First a set of geographic locations is defined. A portion of the set of geographic locations is assigned to a first crawling node. A second portion of the set of geographic locations is assigned to as second crawling node. The first and second crawling nodes then crawl Web content. For each Web page that is located by the first and second crawling nodes a determination is made as to whether the Web page contains a geographic location that belongs the set of geographic locations. If it is determined that the a Web page that is located by either the first or second crawling node does belong to the set of geographic locations, then that Web page is referred to the crawling node to which that geographic location is assigned.

### CROSS-REFERENCE TO RELATED APPLICATIONS

This application claims priority to U.S. Provisional Application No. 60/800,832 filed on May 17, 2006, which is incorporated by reference herein in its entirety.

### FIELD

The embodiments described herein relate to systems and methods for crawling Web content containing geographic locations.

### BACKGROUND

The World Wide Web has become so large that the use of a search engine to find particular Web pages has become very popular. In a typical search engine, a user enters a search string into an appropriate field, and the search engine returns the uniform resource locators (URLs) of Web pages that contain a match.

Search engines utilize software agents, which may be referred to by various names including crawlers and spiders, to search and download various pages from the Web. The search engine then indexes the downloaded Web pages. As is known in the art, search engines typically crawl only a fraction of the World Wide Web.

Many traditional search engines are set up for pure keyword-oriented searches. In particular, their crawling strategies can be quite effective for producing results with respect to keyword searches. However, these search engines are not as effective for other types of searches such as geographically oriented keyword searches. In particular, queries such as “restaurants in New York, N.Y.”, “good plumbers near 100 milam street, Houston, Tex.”, or “romantic hotels in Las Vegas, Nev.” are not properly managed by traditional search engines.

Thus, there is a need for search engines that can effectively crawl the Web to provide useful results for geographically oriented keyword searches. In particular, given that only a fraction of the Web is crawled, in order to ensure efficiency and effectiveness, it is important that a substantial portion of the Web content crawled by the search engine's crawlers is in fact pertinent Web content.

### SUMMARY

The embodiments described herein provide in one aspect, a method of crawling Web content, said method comprising:
a) defining a set of geographic locations;
b) assigning a first portion of the set of geographic locations to a first crawling node;
c) assigning a second portion of the set of geographic locations to a second crawling node;
d) crawling the Web content;
e) for each Web page located by the first and second crawling nodes, determining if the Web page includes a geographic location belonging to the set of geographic locations;
f) if (e) is true, then referring the Web page to the one of the first and second crawling nodes to which the geographic location is assigned.

The embodiments described herein provide in another aspect, system for crawling Web content containing geographic locations, said system comprising:
a) a storage module for storing a set of the geographic locations;
b) a first and second crawling node adapted for communication with the storage module;
   wherein the first crawling node is assigned to a first portion of the set of geographic locations;
   wherein the second crawling node is assigned to a second portion of the set of geographic locations;
   wherein the first and second crawling nodes are adapted to determine if a Web page contains a geographic location from the set of geographic locations;
   wherein the first crawling node is adapted to refer the Web page to the second crawling node if the geographic location belongs to the second portion of the set of geographic locations.

Further aspects and advantages of the embodiments described herein will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the geographically focused Web crawling system according to an embodiment of the present invention;

FIG. 2 is a block diagram of a crawling node of FIG. 1;

FIG. 3 is a flowchart diagram that illustrates the operation of the geographically focused Web crawling system of FIG. 1;

FIG. 4 is a flowchart diagram that illustrates the steps taken by the configuration module;

FIG. 5 is a flowchart diagram that illustrates the operation of each crawling node of the geographically focused Web crawling system of FIG. 1 when crawling the web;

FIG. 6 is a flowchart diagram that illustrates the operation of the analyzer module of FIG. 2 according to the URL based assessment strategy;

FIG. 7 is a flowchart diagram that illustrates the operation of the analyzer module of FIG. 2 according to the extended anchor text based assessment strategy;

FIG. 8 is a flowchart diagram that illustrates the operation of the analyzer module of FIG. 2 according to the full content based assessment strategy;

FIG. 9 is a flowchart diagram that illustrates the operation of the analyzer module of FIG. 2 according to the classification based assessment strategy; and

FIG. 10 is a flowchart diagram that illustrates the operation of the analyzer module of FIG. 2 according to the IP-address based assessment strategy.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The invention may be implemented in hardware or software, or a combination of both. However, the invention is preferably implemented in computer programs executing on programmable computers each comprising at least one processor, a data storage system (including volatile and non-volatile memory and/or storage elements), at least one input device, and at least one output device. For example and without limitation, the programmable computers may be a web server, personal computer, or laptop.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Described herein is a preferred embodiment of a system and method for crawling Web content comprising Web pages or portions of Web pages containing a geographic location. Web content that contains a geographic location will also be referred to as being pertinent to that geographic location. As used herein, a geographic location is any geographical information that represents a physical location. In one embodiment, a geographic location could be a city. For example, in the United States, a geographic location could be represented by an ordered pair comprising a city name and a state name, which may be represented as (cᵢ, sᵢ). In this representation, each member of the ordered pair may be represented by an equivalence class. For example, a particular cᵢ can be an equivalence class containing the city names “L.A.,” “LA,” and “Los Angeles.” Similarly, a particular si can be an equivalence class containing the state names “Arizona” or “AZ.”

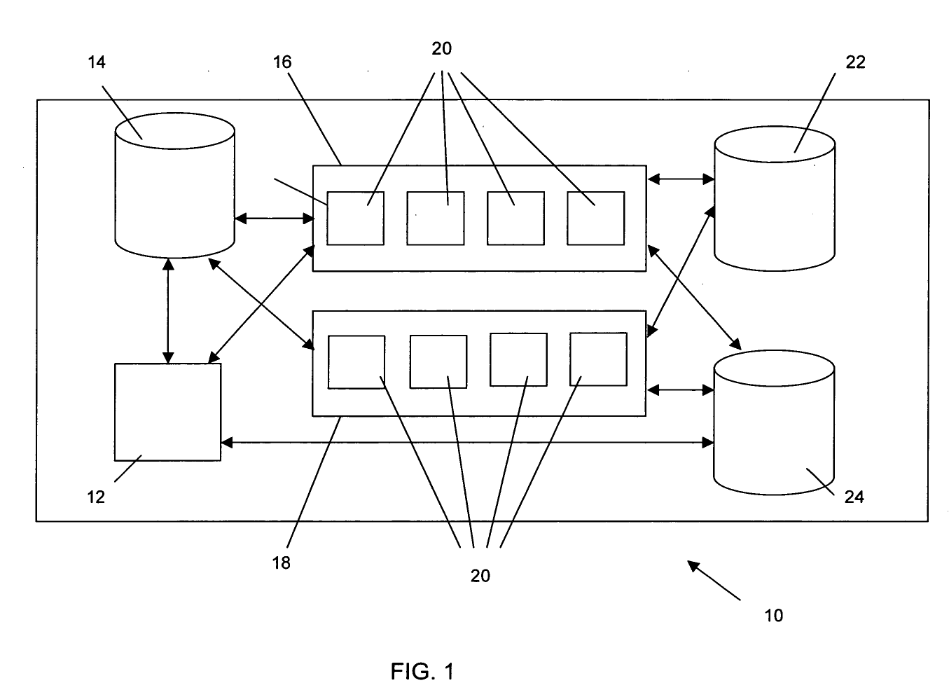

FIG. 1 illustrates an exemplary embodiment of a geographically focused web crawling system 10. Geographically focused web crawling system 10 comprises a number of functional elements including configuration module 12, geographic location storage module 14 geographically focused crawling node set 16, and general crawling node set 18. Each of the sets of crawling nodes 16 and 18 has one or more crawling nodes 20. Geographically focused web crawling system 10 also comprises Web page storage module 22, and assigned geographic location storage module 24.

Configuration module 12, as will be discussed in greater detail below, performs the steps necessary to configure the system. Geographic location storage module 14, stores the set of geographic locations that crawling nodes 20 search for when crawling web content. Web page storage module 22 stores the Web pages downloaded by crawling nodes 20 as they crawl the Web content. Assigned geographic location storage module 24 stores the assignments of portions of the geographic locations to various crawling nodes 20.

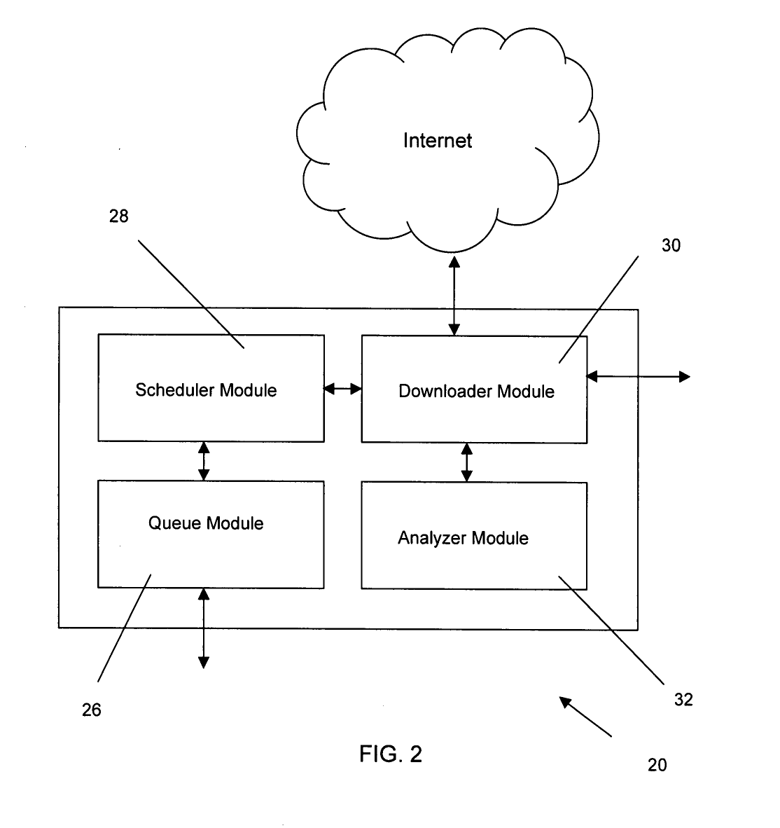

FIG. 2 illustrates a single crawling node 20 of FIG. 1. Each crawling node 20 comprises queue module 26, scheduler module 28, downloader module 30, and analyzer module 32. The queue module 26, stores URLs that the crawling node 20 has not yet crawled. Scheduler module 28 chooses the next URL from queue module 26 that crawling node 20 will crawl. Downloader module 30 downloads the Web content located at the URLs chosen by the scheduler module 28. Analyzer module 28, analyses Web content to determine whether or not the Web content contains a geographic location. In the exemplary embodiment, all crawling nodes have the same architecture. However, it is not intended to exclude embodiments in which different architectures are utilized.

Referring again to FIG. 1, the set of geographically focused crawling nodes 16 comprises one or more crawling nodes 20, each of which crawls according to a crawling strategy that is intended to lead to Web content likely to contain specific geographic locations. In contrast, crawling nodes 20 that belong to the set of general crawling nodes 18 crawl general Web content in search of geographic locations. FIG. 1 shows each of the sets of crawling nodes 16 and 18 as having four crawling nodes 20. However, it should be understood that each of the sets 16 and 18 may have any number of crawling nodes 20. In particular, the number of crawling nodes 20 in one set does not restrict the number of crawling nodes 20 that are available to the other set. As will be explained below, the geographically focused crawling nodes are made to crawl specific Web content by continually providing them with URLs that are likely to pertain to specific geographic locations. The URLs are provided to the crawling nodes 20 by placing them in the queue modules 26.

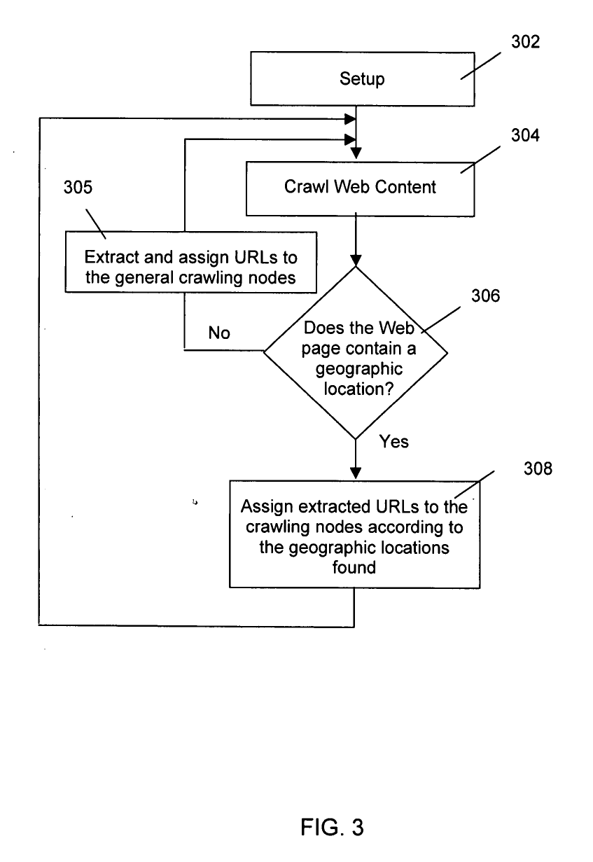

FIG. 3 illustrates the basic steps taken by geographically focused web crawling system 10. At step 302, the configuration module 12, initializes the system 10. This includes defining a set of geographic locations and assigning them to crawling nodes 20. At step 304, crawling nodes 20, crawl the Web. At step 306, analyzer module 32 determines whether a located Web page contains a geographic location. If not, then the process moves to step 305. At step 305, all the URLs from the Web page are extracted and assigned to the crawling nodes 20 in the general crawling node set 18. After step 305 has been completed the process returns to step 304 is repeated. If yes, then at step 308, the Web page is assigned to the crawling node 20 responsible for the location found. Then the process returns to step 304.

There are various methods that may be used to assign URLs to the appropriate crawling nodes in step 308 of FIG. 3. For example, a particular Web page may be found to relate to more than one geographic location. In such a case, one may assign the URL of the Web page to all the crawling nodes responsible for the geographic locations to which the Web page is found to contain. Alternatively, the URL could be assigned to the one crawling node responsible for the geographic location to which the Web page is most pertinent. In the exemplary embodiment, the analyzer module calculates the probability that the Web page contains a geographic location. When this probability is non-zero, then a given Web page is said to contain the geographic location. However, the geographic location for which the Web page is most pertinent is the one for which this probability is the highest.

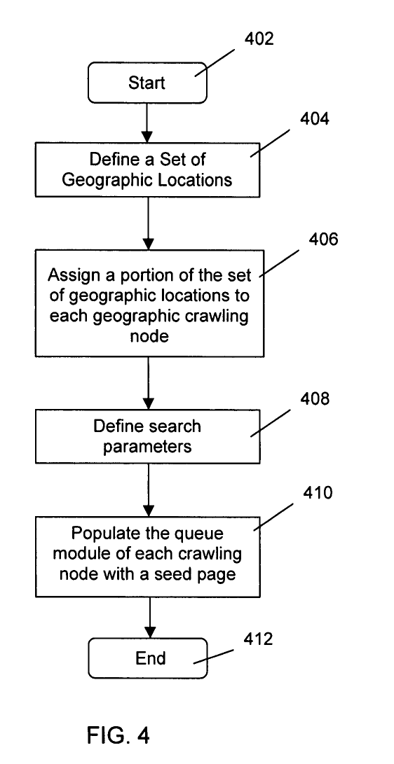

FIG. 4 illustrates the steps taken by the configuration module. The process begins at step 402. At step 404, a set of geographic locations are defined. The set of geographic locations is stored in geographic location storage module 14. The set of geographic locations may comprise any number geographic locations. As explained above, a geographic location may refer to any geographical information that represents a physical location.

At step 406, a portion of the set of geographic locations is assigned to each crawling node 20 that is in the set of geographically focused crawling nodes 16. These assignments of geographic locations are stored in assigned geographic locations storage module 22. The portion size assigned to each crawling node 20 can be of any size. Thus, each crawling node 20 in the set of geographically focused crawling nodes 16 can be assigned one or more geographic locations. In addition, the number of geographic locations in each portion assigned to each crawling node 20 can be different.

At step 408, the search parameters are defined. This includes such criteria as the depth to which each crawling node will crawl each domain and the particular assessment strategy utilized by each crawling node 20. The assessment strategy refers to the manner in which a crawling node determines whether or not a particular Web page is pertinent to a geographic location within the set of geographic locations. As will be explained below, there are a number of different assessment strategies. In addition, each crawling node 20, can utilize its own assessment strategy or one or more crawling nodes 20 may utilize the same assessment strategy. At step 410, queue 26 of each crawling node 20 is populated with a seed page. This is accomplished by entering an appropriate URL into the queue module 32 of each crawling node 20. At step 412, the process ends.

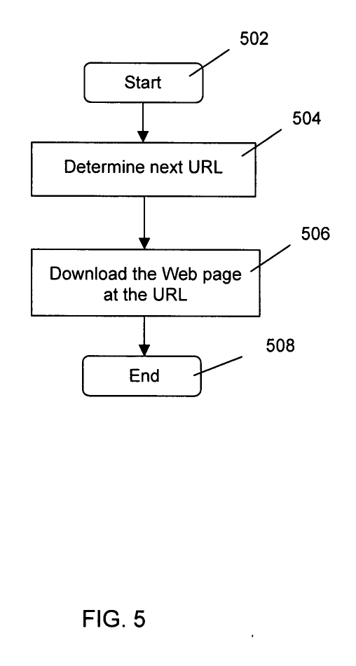

FIG. 5 illustrates the steps taken by each crawling node 20 while crawling the Web. The process begins at step 502. At step 504, scheduler module 28 determines which URL should be chosen next from queue module 26. At step 506, downloader module 30 downloads the webpage located at the chosen URL and stores it in Web page storage module 24. At step 508, the process ends.

As mentioned above, there are many different possible assessment strategies. An assessment strategy is the method utilized by analyzer module 32 to determine whether a particular Web page contains a geographic location from the set of geographic locations. A number of different assessment strategies will now be described including: the URL, extended anchor text, full content, classification, and IP-address assessment strategies. In the exemplary embodiment each crawling node 20 utilizes the same assessment strategy. This ensures that the same Web content would be treated the same way by all crawling nodes. However, it is possible to have each crawling node utilize a different assessment strategy.

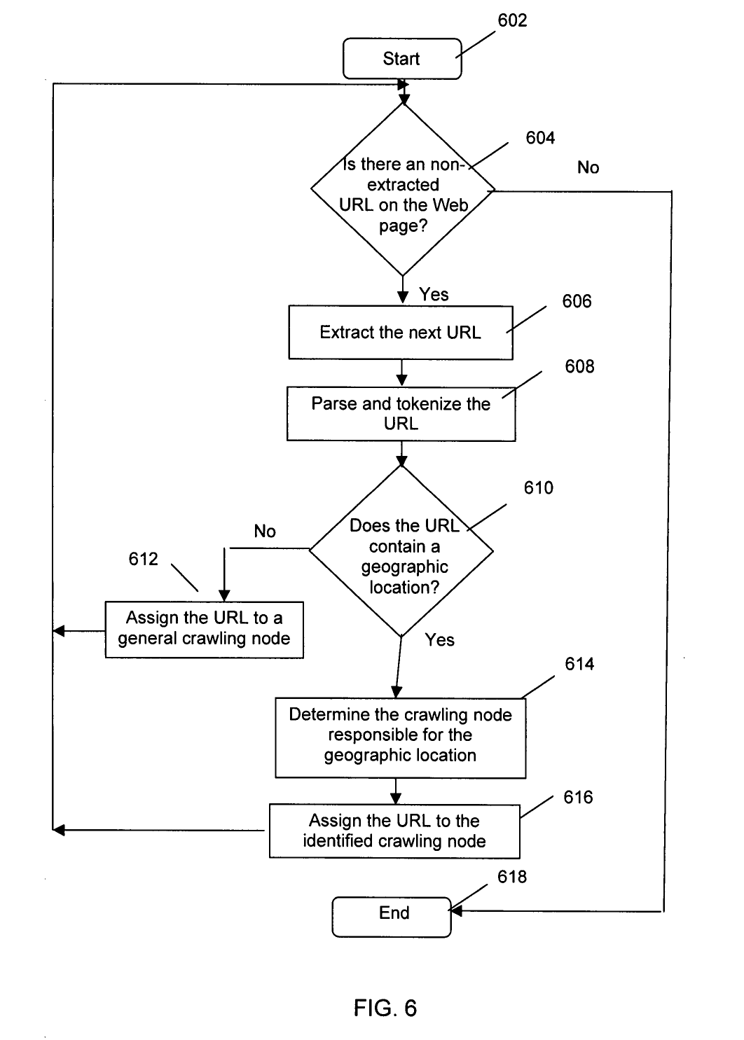

FIG. 6 illustrates the steps taken by the analyzer module 32 according to the URL based assessment strategy. The process begins at step 602. At step 604, it is determined whether the current Web page being crawled contains a URL of another webpage that has not yet been processed. If not, then the process ends at step 618. If yes, then the process continues to step 606.

At step 606, the URL is extracted. At step 608, the URL address is parsed and tokenized. At step 610, it is determined whether or not the extracted URL contains a geographic location. This is in effect a determination of whether or not the Web page at the URL contains a geographic location. An assumption of the URL based assessment strategy is that if the text of the URL of a Web page contains a geographic location, then the Web page contains or is pertinent to a geographic location. If the answer at step 610 is no, then step 612 is executed. At step 612, the URL is assigned to a crawling node 20 in the general crawling node set 18. In some embodiments, there may be only one crawling node 20 in the general crawling node set 18. Therefore, each time step 612 is executed, the URL may be assigned to that same crawling node 20. In various other embodiments, there may be a plurality of crawling nodes 20 in the general crawling node set 18 and at each iteration of step 612, the URL may be assigned to the various crawling nodes 20 of the general crawling node set 18 in any appropriate manner. After step 612 has been completed, the process returns to step 604.

If the answer at step 610 is yes, then step 614 is executed. At step 614, the crawling node 20 to which the geographic location has been assigned is identified. Then at step 616, the URL is assigned to the identified crawling node 20. This is accomplished by placing the URL in the queue module 26 of the appropriate crawling node 20. After step 616 has been completed, the process returns to step 604.

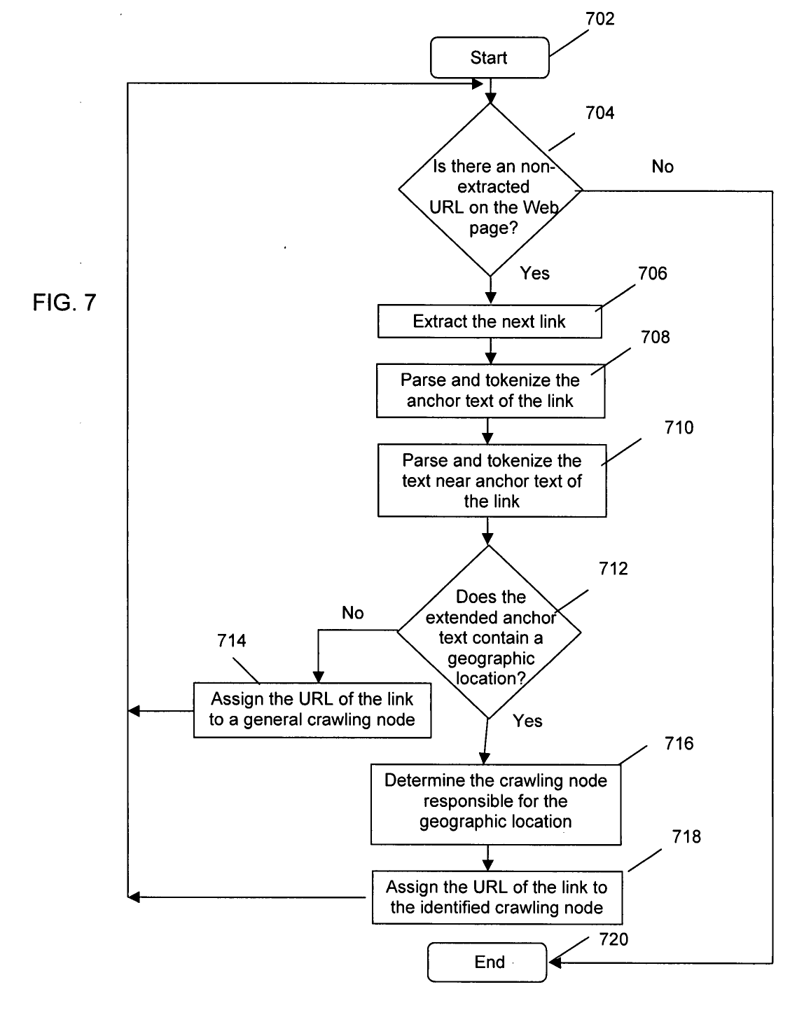

FIG. 7 illustrates the steps taken by the analyzer module 32 according to the extended anchor text based assessment strategy. The term “extended anchor text” refers to the anchor text of a hyperlink as well as to a selected amount of the surrounding text. The amount of surrounding text that is utilized may be defined to be any suitable amount. For example, it may be specified to be a certain number of tokens on either side of the anchor text of the hyperlink. This number of tokens is a parameter, which may for example be determined during the set up process.

The process begins at step 702. At step 704, it is determined whether the current Web page contains a hyperlink that has not yet been processed. If not, then the process ends at step 720. If yes, then the process continues to step 706. At step 706, the next link is extracted. At step 708, the anchor text of the hyperlink is parsed and tokenized. At step 710, a predetermined amount of text, which surrounds the anchor text of the hyperlink, is parsed and tokenized. At step 712, it is determined whether or not the extended anchor text of the hyperlink contains a geographic location. If more than one geographic location appears in the extended anchor text, then any appropriate method can be used to select the geographic location that will be considered to be the geographic location that is contained in the extended anchor text. For example, in some embodiments, if more than one geographic location is found in the extended anchor text, then the geographic location which appears closest to the actual anchor text is chosen as the one which the extended anchor text contains. If two geographic locations are equidistant from the anchor text, then any appropriate method can be used to select a geographic location that is said to be contained in the extended anchor text. Similarly, if two geographic locations appear in the anchor text itself, then any appropriate method can be used to select a geographic location that will be considered to be the geographic location that is contained in the extended anchor text.

If the answer at step 712 is no, then the process moves to step 714. At step 714, the URL of the link is assigned to a crawling node 20 in the general crawling node set 18. In some embodiments, there may be only one crawling node 20 in the general crawling node set 18. Therefore, each time step 714 is executed, the URL may be assigned to that same crawling node 20. In various other embodiments, there may be a plurality of crawling nodes 20 in the general crawling node set 18 and at each iteration of step 714, the URL may be assigned to the various crawling nodes 20 of the general crawling node set 18 in any appropriate manner. After step 714 has been completed, the process returns to step 704.

If the answer at step 712 is yes, then step 716 is executed. At step 716, the crawling node 20 to which the geographic location has been assigned is identified. At step 718, the URL is assigned to the crawling node 20 to which the geographic location has been assigned. This is accomplished by placing the URL in the queue module 32 of the appropriate crawling node 20. After step 718 has been completed, the process returns to step 704.

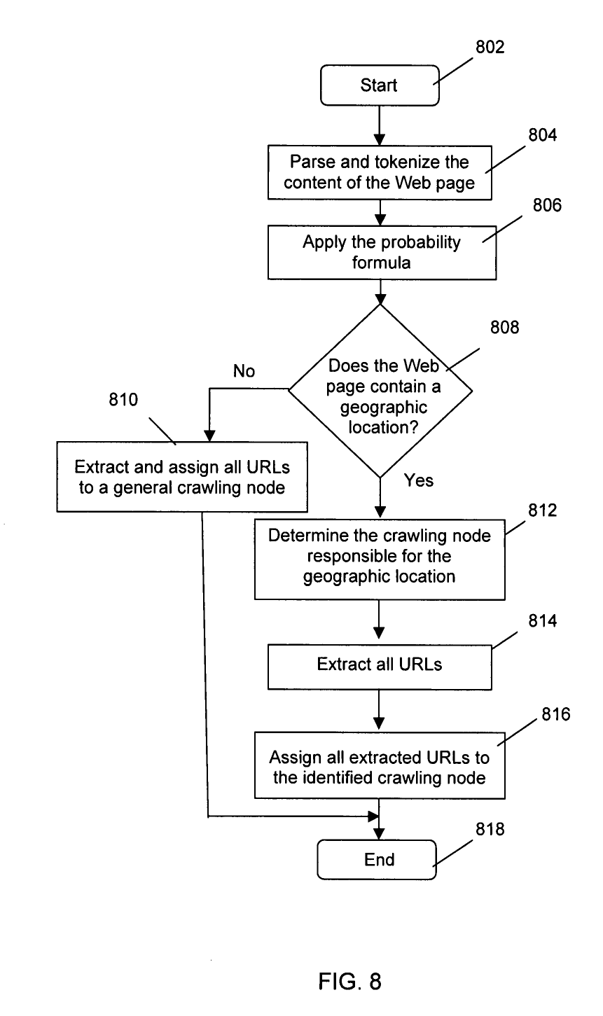

FIG. 8 illustrates the steps taken by the analyzer module 32 according to the full content based assessment strategy. According to this method a portion of the content appearing on the Web page is analyzed in order to determine whether there is a geographic location present. The choice of the portion to be analyzed is a parameter that can, for example, be determined during the set up of the system. In one embodiment, the entire content of the Web page is examined.

The process begins at step 802. At step 804, the content of the desired portion of the Web page is parsed and tokenized. At step 806, a probability formula is applied. The particular formula applied is dependent on such things as the type of members of the set of geographic locations. Below, a probability formula for a particular implementation of the exemplary embodiment will be presented. In that particular implementation, the members of the set of geographic locations are U.S. city-state pairs. However, it should be understood that in various other embodiments other geographic locations may be utilized.

At step 808, based on the result obtained from the application of the formula, it is determined whether the Web page contains a geographic location belonging to the set of geographic locations. This in turn is treated as a determination as to whether the Web pages to which the current Web page links contain a geographic location belonging to the set of geographic locations. Thus, the full content assessment strategy operates under the assumption that if a given Web page contains a geographic location belonging to the set of geographic locations, then all the Web pages to which it links also contain the same geographic location. Similarly, it assumes that if a given Web page does not contain a geographic location belonging to the set of the geographic locations, then neither do any of the Web pages to which it links.

If the result of step 808 is no, then step 810 is executed. At step 810, all the URLs that appear on the Web page are extracted and assigned to one or more crawling nodes 20 in the general crawling node set 18. In some embodiments, there may be only one crawling node 20 in the general crawling node set 18 and therefore all URLs at step 810 may be assigned to that crawling node 20. In various other embodiments, there may be a plurality of crawling nodes 20 in the general crawling node set 18 and at step 810, the URLs may be assigned to the various crawling nodes 20 in any appropriate manner. After step 810, the process ends at step 818.

If the result of step 808 is yes, then step 812 is executed. At step 812, it is determined to which crawling node 20 the geographic location identified in step 808 is assigned. At step 814, all the URLs from current Web page are extracted. At step 816, all the URLs are assigned to the crawling node 20 identified at step 812. This is accomplished by placing the URLs in the queue module 26 of the appropriate crawling node 20. Then at step 818, the process ends.

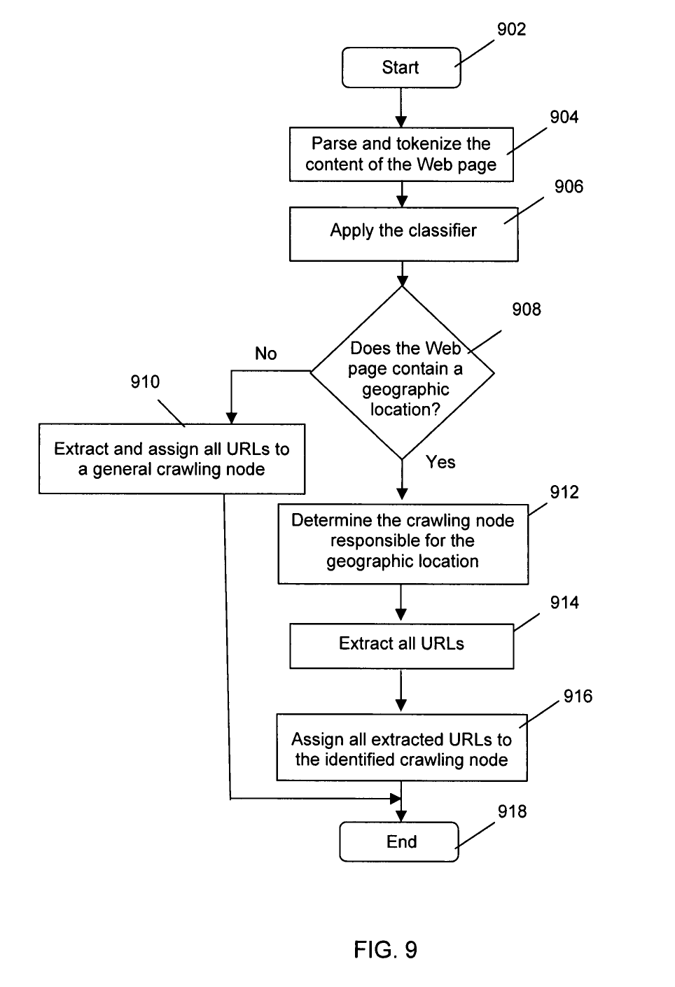

FIG. 9 illustrates the steps taken by the analyzer module 32 according to the classification assessment strategy. This method utilizes a probabilistic classifier. A classifier is a mapping tool. The classifier is used to determine the probability that a given Web page is pertinent to a geographic location in the set of geographic locations. The classes of the classifier are the portions of the set of geographic locations assigned to each crawling node 20 in the set of geographically focused crawling nodes 16. During the set up process, a supervised learning process is used to train the classifier to determine the probability that a particular page is pertinent to one of the locations in the set of geographic locations. The training data used to train the classifier can be Web pages known to be pertinent to locations belonging to the set of geographic locations as well as Web pages known to be not pertinent to any locations within the set of geographic locations. In one embodiment, the classifier is a Naïve-Bayes classifier.

The process begins at step 902. At step 904, a portion of the content of the Web page is parsed and tokenized. At step 906, the classifier is applied. At this step the classifier determines the probability that the given currently crawled page p is pertinent to each geographic location in the set of geographic locations.

At step 908, it is determined whether or not the web page contains a geographic location. This is accomplished by determining whether the result of step 906 yielded at least one non-zero probability. The geographic location which the Web page is deemed to contain is the one with the highest probability. In the event that two or more geographic locations are found to have the same probability, analyzer module 32 preferably chooses randomly between the two geographic locations. As with the full content assessment strategy, this determination is taken as a determination as to whether the Web pages to which the current Web page links contain a geographic location belonging to the set of geographic locations. Thus, the classifier assessment strategy operates under a similar assumption as that of the full content assessment strategy. If a given Web page contains a geographic location belonging to the set of geographic locations, then all the Web pages to which it links are assumed to contain the same geographic location. Similarly, if a given Web page does not contain a geographic location belonging to the set of the geographic locations, then it is assumed that neither do any of the Web pages to which it links.

If the result of step 908 is no, then step 910 is executed. At step 910, all the URLs that appear on the Web page are extracted and assigned to one or more crawling nodes 20 in the general crawling node set 18. In some embodiments there is only one crawling node 20 in the general crawling node set 18 and therefore all URLs at step 910 may be assigned to that crawling node 20. In various other embodiments, there may be a plurality of crawling nodes 20 in the general crawling node set 18 and at step 910, the URLs may be assigned to the various crawling nodes 20 in any appropriate manner. After step 910 is completed the process ends at step 918.

However, if the result of step 908 is yes, then step 912 is executed. At step 912, the crawling node 20 to which the geographic location has been assigned is identified at step 908. At step 914, all the URLs from the current Web page are extracted. At step 916, all the URLs are assigned to the crawling node 20 identified at step 912. This is accomplished by placing the URL in the queue of the identified crawling node 20. Then at step 918, the process ends.

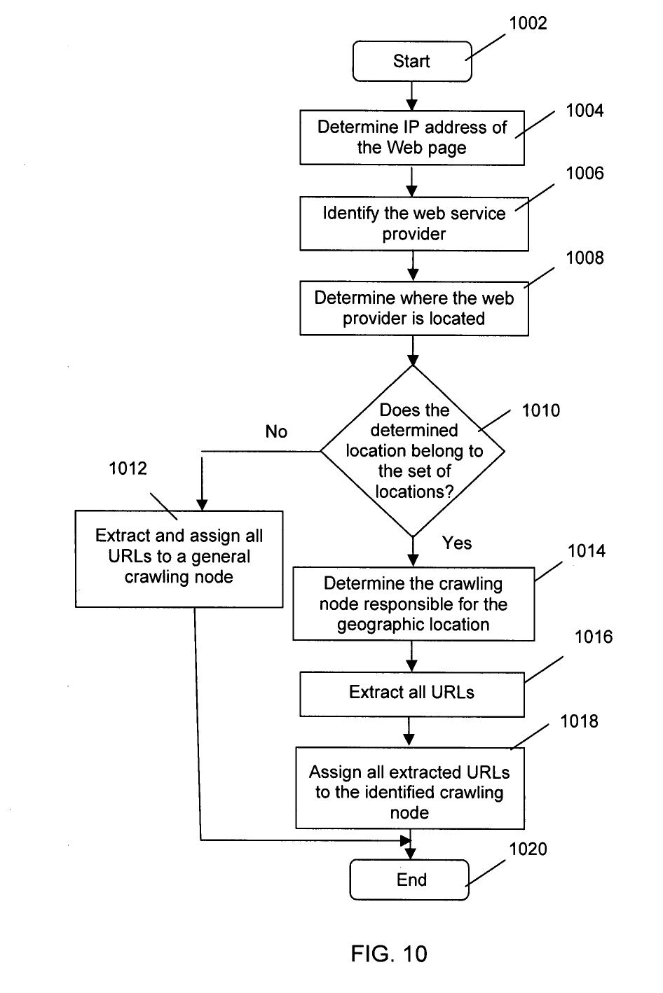

FIG. 10 illustrates the steps taken by the analyzer module 32 according to IP-address assessment strategy. The process begins at step 1002. At step 1004, the IP-address of the Web page is determined. At step 1006, the web service provider corresponding to the IP address is identified. At step 1008, the location of the web service provider is determined.

At step 1010, it is determined whether the location at which the web service is situated is a location in the set of geographic locations. Alternatively, step 1010 could determine whether there is a location in the set of geographic locations that is within a minimum distance of the location at which the web service provider is situated. As with the two previous assessment strategies, this determination is treated as a determination of whether the Web pages, to which the current Web page links, contain a geographic location belonging to the set of geographic locations. Thus, the classifier assessment strategy operates under a similar assumption to the full content and classification assessment strategies. In particular, it is assumed that if a given Web page contains a geographic location belonging to the set of geographic locations, then all the Web pages to which it links also contain the same geographic location. Similarly, it assumes that if a given Web page does not contain a geographic location belonging to the set of the geographic locations, then neither do any of the Web pages to which it links.

If the result of step 1010 is no, then step 1012 is executed. At step 1012 all the URLs that appear on the Web page are extracted and assigned to one or more crawling nodes 20 in the general crawling node set 18. In some embodiments there is only one crawling node 20 in the general crawling node set 18 and therefore all URLs at step 1010 may be assigned to that crawling node 20. In various other embodiments, there may be a plurality of crawling nodes 20 in the general crawling node set 18 and at step 1010, the URLs may be assigned to the various crawling nodes 20 in any appropriate manner. After step 1010, the process ends at step 910. However, if result of step 1010 is yes, then step 1014 is executed. At step 1014, the crawling node 20 responsible for the geographic location is identified. At step 1016, all the URLs present in the Web page are extracted. At step 1018, all the URLs are assigned to the crawling node 20 identified in step 1014. This is accomplished by placing the URL in the queue module 26 of the identified crawling node 20. Then at step 1020, the process ends.

Five different implementations of the exemplary embodiment have been developed. In each case, the set of geographic locations comprises the 100 most populous U.S. cities. The list of these cities was obtained form http://www.city-data.com. Each one of these geographic locations is represented as a city-state pair. Thus, the set of geographic locations may be represented as TC={(c₁, s₁), . . . , (c₁₀₀, s₁₀₀)}, wherein each (cᵢ, sᵢ) is a city-state pair.

In each of these implementations, the geographically focused web crawling system 10 comprises 6 crawling nodes 20, which can be represented as Cn₀ through Cn₅. The set of general crawling nodes 18 comprises one crawling node Cn₀. The set of geographically focused crawling nodes 16 comprises 5 crawling nodes, Cn₁ through Cn₅. The city-state pairs are divided among the crawling nodes 20 according to the time zone within which they are located. Cn₀ is not assigned any cities, as it belongs to the set of general crawling nodes 18. The cities in the Eastern time zone are assigned to node Cn₁, those in the Pacific time zone are assigned to Cn₂, those in the Mountain time zone are assigned to Cn₃, those in the Central time zone are assigned to Cn₄, and finally those in the Hawaii-Aleutian and Alaskan time zones are assigned to Cn₅. Table 1 illustrates the cities and their assignments.

TABLE 1

| | Time | State | |
|---|---|---|---|
| Node | Zone | Name | Cities |
| Cₙ₀ | None | None | None |
| Cₙ₁ | Eastern | DC | Washington |
| | | FL | Hialeah, Miami |
| | | GA | Atlanta, Augusta-Richmond County |
| | | KE | Lexington-Fayette, Louisville |
| | | MD | Baltimore |
| | | MA | Boston |
| | | MI | Detroit, Grand Rapids |
| | | NJ | Newark, Jersey City |
| | | NY | New York, Buffalo, Rochester, Yonkers |
| | | NC | Charlotte, Raleigh, Greensboro |
| | | OH | Durham, Winston-Salem, Columbus, Cleveland |
| | | PA | Philadelphia, Pittsburgh |
| | | VI | Virginia Beach, Norfolk, Chesapeake, |
| | | | Richmond, Arlington |
| Cₙ₂ | Pacific | CA | Los Angeles, San Diego, San Jose, San |
| | | | Francisco, Long Beach, Fresno, Oakland, Santa |
| | | | Ana, Anaheim, Bakersfield, Stockton, Fremont, |
| | | | Glendale, Riverside, Modesto, Sacramento, |
| | | | Huntington Beach |
| | | NV | Las Vegas |
| | | OR | Portland |
| | | WA | Seattle, Spokane, Tacoma |
| Cₙ₃ | Mountain | AZ | Phoenix, Tucson, Mesa, Glendale, Scottsdale |
| | | Co | Denver, Colorado Springs, Aurora |
| | | ID | Boise |
| | | NM | Albuquerque |
| Cₙ₄ | Central | AL | Birmingham, Montgomery, Mobile |
| | | IL | Chicago |
| | | IN | Indianapolis, Fort Wayne |
| | | IA | Des Moines |
| | | KA | Wichita |
| | | LO | New Orleans, Baton Rouge, Shreveport |
| | | MN | Minneapolis, St. Paul |
| | | MO | Kansas City, St Louis |
| | | NE | Omaha, Lincoln |
| | | OK | Cincinnati, Toledo, Akron, Oklahoma City, |
| | | | Tulsa |
| | | TX | Houston, Dallas, San Antonio, Austin, El Paso, |
| | | | Fort Worth, Arlington, Corpus Christi, Plano, |
| | | | Garland, Lubbock, Irving |
| | | WI | Milwaukee, Madison |
| Cₙ₅ | Alaska | AK | Anchorage |
| | Hawaii | HI | Honolulu |

The crawling nodes are implemented through a re-developed version of the open source crawler, larbin written in C++. The unmodified version of larbin was obtained at http://larbin.sourceforge.net/index-eng.html and was then re-developed. Each crawling node digs each domain name up to a maximum of five levels of depth. The crawling nodes are implemented over 2 servers.

For each of the crawling nodes in these implementations of the exemplary embodiment, the same seed page is used: http://www.dmoz.org/Regional/North_America/United_States/. This page is part of the open directory project. This specific seed page corresponds to the following category: “Top: Regional: North America: United States.”

The five implementations of the exemplary embodiment differ in the assessment strategy utilized by crawling nodes 20. In each implementation, all the crawling nodes 20 follow the same assessment strategy. Thus, each implementation uses one of the following assessment strategies: URL based, Extended Anchor Text Based, Full content based, classification based and IP address based assessment strategy. However, it is not intended to exclude embodiments in which a combination of various assessment strategies is utilized.

As discussed above, the URL assessment strategy examines the text of the URL of each extracted URL from the current Web page p. In the case of the implementation utilizing city-state pairs, the URL assessment strategy checks for the presence of a city-state pair that belongs to the set of geographic locations, i.e. all (cᵢ, sᵢ) ∈ TC, in the text of the URL. If a city sate pair belonging to the set of geographic locations is found then the URL is assigned to the appropriate crawling node Cnᵢ.

The extended anchor text, as was explained above, examines the anchor text and surrounding text for the presence of a city-state pair that belongs to the set of geographic locations, i.e. (cᵢ, sᵢ) ∈ TC, in the extended anchor text of the link. If a city sate pair belonging to the set of defined geographic locations is found, then the URL to which the link leads is assigned to the appropriate crawling node Cnᵢ.

As explained above, the IP address method examines the IP-address of the current Web page p being crawled. The IP address can be used to determine the location at which the web service hosting the page is located. An IP address mapping tool, such as, but not limited to, hostip.info (API), can be used to determine the physical location of the web service provider. This location is then compared to the set of geographic locations in order to determine if it corresponds to one of the city-state pairs (cᵢ, sᵢ) ∈ TC. If it does, then all the URLs from the Web page p are assigned to the appropriate crawling node Cnᵢ.

As discussed above, the full content based method examines each Web page and determines whether the Web page contains a geographic location. As used herein, the term Web page may refer to an entire Webpage or a portion of a Web page. The determination of whether the Web page contains a geographic location can be accomplished by, for each city-state pair, calculating the probability that the Web page p is pertinent to that city-state pair. After each of these calculations is made, the probabilities are compared and the city-state pair with the highest probability is chosen as being the one that the Web page contains. In addition, in the exemplary embodiment, the probability is compared to a threshold value, which may be set to any suitable value. If no geographic location is found to have a probability above the threshold value, then the Web page p will be deemed not to contain any geographic location. All the URLs from the Web page are assigned to the crawling node responsible for that city-state pair.

The calculation at step 806 of FIG. 8 can be carried out as follows. The probability that the Web page p is pertinent to a given city-state pair is denoted as pr(cᵢ, sᵢ)|p). Thus, pr((cᵢ, sᵢ)|p) is calculated for all (cᵢ, sᵢ) ∈ TC and the maximum value is chosen. In other words, arg max_{(c}_{ᵢ}_{,s}_{ᵢ}_{)∈TC} pr((cᵢ, sᵢ)|p) is calculated.

The probability pr((cᵢ, sᵢ)|p) can be expressed as:

pr(cᵢ,sᵢ)|p)=α·#((cᵢ,sᵢ),p)+(1−α)·pr(sᵢ|cᵢ)·#(cᵢ,p) (1)

where #((cᵢ, sᵢ),p) denotes the number of times that the city-state pair (cᵢ, sᵢ) appears as part of the content of a Web page p, #(cᵢ, p) denotes the number of times, independent of #((cᵢ, sᵢ),p), that the city cᵢ appears as part of the content of Web page p, and α is a weighting factor. In the implementation of the exemplary embodiment, α=0.7 is utilized.

In order to calculate a value for pr(sᵢ|cᵢ), two simplifying assumptions are made. First, it is assumed that pr(sᵢ|cᵢ) is dependent on the population of (cᵢ, sᵢ). Secondly, it is assumed pr(sᵢ|cᵢ) is dependent on the number of times that the state reference, sᵢ, independent of #((cᵢ, sᵢ),p), appears as part of the content of Web page p. Thus, pr(sᵢ|cᵢ) may be expressed as:

pr(sᵢ|cᵢ)∝ βS(sᵢ|cᵢ)+(1−β)\tilde{S}(sᵢ|p) (2)

where S(sᵢ|cᵢ) is the normalized population of (cᵢ, sᵢ), \tilde{S}(sᵢ|p) is the normalized number of appearances of the state reference sᵢ, independent of #((cᵢ, sᵢ),p), as part of the content of Web page p, and β is a weighting factor. In the implementation of the exemplary embodiment β=0.5 is utilized. Thus, substituting equation (2) into equation (1) and replacing the proportionality sign with an equality sign yields:

pr((cᵢ,sᵢ)|p)=α·#((cᵢ,sᵢ),p)+(1−α)·(βS(sᵢ|cᵢ)+(1−β)\tilde{S}(sᵢ|p))·#(cᵢ,p) (3)

The classifier in the implementation of the exemplary embodiment utilizing the classification based assessment strategy is a Naïve-Bayes classifier. Other classifiers could be used as well. The Naïve-Bayes classifier is utilized because it combines both simplicity and effectiveness. The Naïve-Bayes classifier is a simple linear probabilistic classifier that is trained in a supervised leaning environment.

As part of the set up process the classifier is trained to determine the probability that a given Web page p, contains a geographic location (cᵢ, sᵢ). According to the notation introduced above, this probability may be expressed as pr(cᵢ, sᵢ)|p) However, as was previously discussed, the geographic location with the highest probability is the one that the Web page is deemed to be pertinent to. Thus, the URLs from the Web page p are assigned to the crawling node responsible for the city-state pair which satisfies the expression: arg max_{(c}_{ᵢ}_{,s}_{ᵢ}_{)∈TC}pr(cᵢ, sᵢ)|p).

The training data for the classifier was taken from the open directory project (ODP), which was located at http://www.dmoz.org. For each geographic location, which in the case of this implementation is a U.S. city-state pair, all pages under the city-state category, which in turn, is the child category for the “REGIONAL” category in the ODP were downloaded. The number of such Web pages varied from 500 to 2000 depending on the city-state pair. A set of 2000 randomly chosen Web pages was also downloaded. These latter Web pages were not part of any city-state category in the ODP. These two sets of data were used to train the classifier.

### Aliasing and Ambiguity

The analyzer module 32 of each crawling node 20 is preferably able to deal with the issues of ambiguity and aliasing.

Aliasing refers to the concept that a particular geographic location may be represented in a variety of different ways. Specifically, in the case where the geographic locations are cities, each city may have various representations. For example, Los Angeles may be represented as Los Angeles, LA or L.A. The five above-described implementations of the exemplary embodiment deal with this issue by using a database provided by the United States Postal Service (USPS) at http://www.usps.gov. This database returns a list of variations for the city name when a corresponding zip code is entered. Thus, in order to obtain the appropriate zip codes for each city a U.S. Zip Code database product was purchased from ZIPWISE. After obtaining the appropriate zip codes the USPS database was used to find the list of variations of city names.

Ambiguity refers to the problem of determining whether a sequence of tokens corresponds to a particular geographic location. For example, it is not possible to always ensure that a city name refers to a particular city. First, a given city name may refer to a number of different cities. For example, four different states including New York, Georgia, Oregon and California, all have a city named Albany. Thus, if the city name appeared on its own it may not be possible to accurately determine which city is being referred to in all cases. A second aspect of ambiguity is the fact that a city name may be used to refer to something other than a city. For example, New York can refer to a state or New York could appear as part of a trademark, as in New York Fries™.

Ambiguity arises with respect to all of the assessment strategies presented above except the IP address assessment strategy. With respect to the full content based assessment strategy, ambiguity can be accounted for within the equation used to analyze the Web page. In the equations presented above, the term pr(sᵢ|cᵢ) captures the notion of ambiguity, as it expresses the probability that a city name appearing on its own refers to a particular city-state pair. Similarly, for the classification based method, the issue of ambiguity and how to deal with it is incorporated into the training process. The extended anchor based method and the URL based method treat an ambiguous city name as referring to the city with the largest population. Thus, word Glendale appearing on its own would be treated as referring to Glendale, Ariz.

It will be appreciated that while the present invention has been described in the context of various methods including crawling Web content containing geographic locations, other types of crawling applications are also applicable. The system, processes and methods of the present invention are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method of crawling Web content comprising:
(a) defining a set of geographic locations;
(b) assigning a first portion of the set of geographic locations to a first crawling node;
(c) assigning a second portion of the set of geographic locations to a second crawling node;
(d) crawling the Web content;
(e) for each Web page located by the first and second crawling nodes, determining if the Web page includes a geographic location belonging to the set of geographic locations;
(f) if (e) is true, then referring the Web page to the one of the first and second crawling nodes to which the geographic location is assigned.

2. The method of claim 1, further comprising:
(g) providing a third crawling node;
wherein step (e) further comprises for each Web page located by the first, second and third crawling nodes, determining if the Web page includes a geographic location belonging to the set of geographic locations.

3. The method of claim 1, wherein step (e) further comprises:
(i) determining the crawling node to which the geographic location is assigned;
(ii) extracting all Uniform Resource Locators from the Web page; and
(iii) assigning all the extracted Uniform Resource Locators to the crawling node to which the geographic location is assigned.

4. The method of claim 1 wherein, the geographic location is a city.

5. The method of claim 1 wherein, the geographic location is a city state pair.

6. The method of claim 1 wherein, the geographic location is a city country pair.

7. The method of claim 1 wherein, the geographic location is a city state country 3-tuple.

8. The method of claim 1, wherein step (e) further comprises determining if a Uniform Resource Locator of the Web page includes a geographic location belonging to the set of geographic locations.

9. The method of claim 8, wherein step (e) further comprises:
(i) extracting the Uniform Resource Locator;
(ii) parsing the Uniform Resource Locator;
(iii) tokenizing the Uniform Resource Locator to produce tokens; and
(iv) analyzing the tokens to determine if the Uniform Resource Locator contains a geographic location belonging to the set of geographic locations.

10. The method of claim 1, wherein step (e) further comprises determining if an extended anchor text of a hyperlink linking to the Web page includes a geographic location belonging to the set of geographic locations.

11. The method of claim 10, wherein the extended anchor text comprises an anchor text of the hyperlink and a predetermined number of tokens on either side of the anchor text.

12. The method of claim 10, wherein step (e) further comprises:
(i) extracting the hyperlink;
(ii) parsing the extended anchor text of the hyperlink;
(iii) tokenizing the extended anchor text;
(iv) analyzing the tokens to determine if the extended anchor text contains a geographic location belonging to the set of geographic locations.

13. The method of claim 1, wherein step (e) further comprises determining if a content of the Web page includes a geographic location belonging to the set of geographic locations.

14. The method of claim 13, wherein step (e) further comprises:
(i) parsing the content of the Web page;
(ii) tokenizing the content of the Web page; and
(iii) analyzing the tokens to determine if the Web page contains a geographic location belonging to the set of geographic locations.

15. The method of claim 14, wherein (iii) further comprises applying a probability formula to determine the probability that the content of the Web page contains a geographic location belonging to the set of geographic locations.

16. The method of claim 15, wherein the probability formula is arg max_{(c}_{ᵢ}_{,s}_{ᵢ}_{)∈TC}pr(cᵢ, sᵢ)|p), where p denotes a Web page, (cᵢ, sᵢ) denotes a city state pair, where cᵢ is a city and sᵢ is a state, pr((cᵢ, sᵢ)|p) denotes the probability that the content of Web page p includes city state pair (cᵢ, sᵢ), and TC denotes the set of geographic locations.

17. The method of claim 16, wherein pr((cᵢ, sᵢ)|p) is approximated as α·#((cᵢ, sᵢ),p)+(1−α)·(βS(sᵢ|cᵢ)+(1−β)\tilde{S}(sᵢ|p))·#(cᵢ, p), wherein α is a weighting factor, where #((cᵢ, sᵢ),p) denotes the number of times that the city-state pair (cᵢ, sᵢ) appears as part of the content of Web page p, β is a weighting factor, S(sᵢ|cᵢ) is a normalized population of (cᵢ, sᵢ), \tilde{S}(sᵢ|p) is a normalized number of appearances of the state reference sᵢ, independent of #((cᵢ, sᵢ),p), as part the content of Web page p, and #(cᵢ, p) denotes the number of times, independent of #((cᵢ, sᵢ),p), that the city cᵢ appears as part of the content of Web page p.

18. The method of claim 1, wherein step (e) further comprises:
(i) parsing the content of the Web page;
(ii) tokenizing the content of the Web page; and
(iii) applying a classifier to the Web page to determine if the Web page includes a geographic location belonging to the set of geographic locations.

19. The method of claim 18, further comprising training the classifier.

20. The method of claim 1, wherein step (e) further comprises determining if an Internet Protocol address of the Web page corresponds to a web service provider having a web service provider location that corresponds to a geographic location belonging to the set of geographic locations.

21. The method of claim 20, wherein step (e) further comprises:
(i) determining the Internet Protocol address of the Web page;
(ii) identifying the web service provider based on the Internet Protocol address;
(iii) determining the web service provider location;
(iv) determining whether the web service provider location corresponds to a geographic location belonging to the set of geographic locations.

22. The method of claim 21, wherein step (iii) further comprises utilizing an IP address mapping tool to determine the location of the web service provider.

23. A system for crawling Web content containing geographic locations, the system comprising:
(a) a storage module for storing a set of the geographic locations;
(b) a first and second crawling node adapted for communication with the storage module;
wherein the first crawling node is assigned to a first portion of the set of geographic locations;
wherein the second crawling node is assigned to a second portion of the set of geographic locations;
wherein the first and second crawling nodes are adapted to determine if a Web page contains a geographic location from the set of geographic locations;
wherein the first crawling node is adapted to refer the Web page to the second crawling node if the geographic location belongs to the second portion of the set of geographic locations.

24. The system of claim 23, further comprising:
(c) a third crawling node;
wherein the third crawling node is adapted to determine if a Web page contains a geographic location from the set of geographic locations;
wherein the third crawling node is adapted to refer the Web page to the first crawling node if the geographic location belongs to the first portion of the set of geographic locations;
wherein the third crawling node is adapted to refer the Web page to the second crawling node if the geographic location belongs to the second portion of the set of geographic locations.

25. The system of claim 23, wherein each crawling node is adapted to:
(i) determine the crawling node to which the geographic location is assigned;
(ii) extract all Uniform Resource Locators from the Web page; and
(iii) assign all the extracted Uniform Resource Locators to the crawling node to which the geographic location is assigned.

26. The system of claim 23 wherein, the geographic location is a city.

27. The system of claim 23 wherein, the geographic location is a city state pair.

28. The system of claim 23 wherein, the geographic location is a city country pair.

29. The system of claim 23 wherein, the geographic location is a city state country 3-tuple.

30. The system of claim 23, wherein each crawling node is adapted to determine if a Uniform Resource Locator of the Web page includes a geographic location belonging to the set of geographic locations.

31. The system of claim 30, wherein each crawling node is adapted to:
(i) extract the Uniform Resource Locator;
(ii) parse the Uniform Resource Locator;
(iii) tokenize the Uniform Resource Locator to produce tokens; and
(iv) analyze the tokens to determine if the Uniform Resource Locator contains a geographic location belonging to the set of geographic locations.

32. The system of claim 23, wherein each crawling node is adapted to determine if an extended anchor text of a hyperlink linking to the Web page includes a geographic location belonging to the set of geographic locations.

33. The system of claim 32, wherein the extended anchor text comprises an anchor text of the hyperlink and a predetermined number of tokens on either side of the anchor text.

34. The system of claim 32, wherein each crawling node is adapted to:
(i) extract the hyperlink;
(ii) parse the extended anchor text of the hyperlink;
(iii) tokenize the extended anchor text;
(iv) analyze the tokens to determine if the extended anchor text contains a geographic location belonging to the set of geographic locations.

35. The system of claim 23, wherein each crawling node is adapted to determine if a content of the Web page includes a geographic location belonging to the set of geographic locations.

36. The system of claim 35, wherein each crawling node is adapted to:
(i) parse the content of the Web page;
(ii) tokenize the content of the Web page; and
(iii) analyze the tokens to determine if the Web page contains a geographic location belonging to the set of geographic locations.

37. The method of claim 36, wherein (iii) further comprises applying a probability formula to determine the probability that the content of the Web page contains a geographic location belonging to the set of geographic locations.

38. The method of claim 37, wherein the probability formula is arg max_{(c}_{ᵢ}_{,s}_{ᵢ}_{)∈TC}pr((cᵢ, sᵢ)|p), where p denotes a Web page, (cᵢ, sᵢ) denotes a city state pair, where cᵢ is a city and sᵢ is a state, pr((cᵢ, sᵢ)|p) denotes the probability that the content of Web page p includes city state pair (cᵢ, sᵢ), and TC denotes the set of geographic locations.

39. The method of claim 38, wherein pr((cᵢ, sᵢ)|p) is approximated as α·#((cᵢ, sᵢ),p)+(1−α)·(βS(sᵢ|cᵢ)+(1−β)\tilde{S}(sᵢ|p))·#(cᵢ, p), wherein α is a weighting factor, where #((cᵢ, sᵢ),p) denotes the number of times that the city-state pair (cᵢ, sᵢ) appears as part of the content of Web page p, β is a weighting factor, S(sᵢ|cᵢ) is a normalized population of (cᵢ, sᵢ), \tilde{S}(sᵢ|p) is a normalized number of appearances of the state reference sᵢ, independent of #((cᵢ, sᵢ),p), as part the content of Web page p, and #(cᵢ, p) denotes the number of times, independent of #((cᵢ, sᵢ),p), that the city cᵢ appears as part of the content of Web page p.

40. The system of claim 26, wherein each crawling node is adapted to:
(i) parse the content of the Web page;
(ii) tokenize the content of the Web page; and
(iii) apply a classifier to the Web page to determine if the Web page includes a geographic location belonging to the set of geographic locations.

41. The system of claim 40, wherein each crawling node is adapted to train the classifier.

42. The system of claim 26, wherein each crawling node is adapted to determine if an Internet Protocol address of the Web page corresponds to a web service provider having a web service provider location that corresponds to a geographic location belonging to the set of geographic locations.

43. The system of claim 42, wherein each crawling node is adapted to:
(i) determine the Internet Protocol address of the Web page;
(ii) identify the web service provider based on the Internet Protocol address;
(iii) determine the web service provider location;
(iv) determine whether the web service provider location corresponds to a geographic location belonging to the set of geographic locations.

44. The system of claim 43, wherein each crawling node is adapted to utilize an IP address mapping tool to determine the location of the web service provider.

45. A computer-readable medium upon which a plurality of instructions are stored, the instructions for performing the steps of:
(a) defining a set of geographic locations;
(b) assigning a first portion of the set of geographic locations to a first crawling node;
(c) assigning a second portion of the set of geographic locations to a second crawling node;
(d) crawling the Web content;
(e) for each Web page located by the first and second crawling nodes, determining if the Web page includes a geographic location belonging to the set of geographic locations;
(f) if (e) is true, then referring the Web page to the one of the first and second crawling nodes to which the geographic location is assigned.
